(19) United States
(12) Patent Application Publication
(10) Pub. No.: US 2008/0001506 A1
(43) Pub. Date: Jan. 3, 2008

(54) Panel Having a Chemical Resistant Work Surface

(76) Inventors: Gary J. Fitzpatrick, Woolloongabba (AU); Shawn M. Galvin, Thirlmere (AU); Goeffrey Deeble, Canberra City (AU)

Correspondence Address: EDWARDS ANGELL PALMER & DODGE LLP, P.O. BOX 55874, BOSTON, MA, 02205, US

(21) Appl. No.: 11/791,497

(22) PCT Filed: Nov. 21, 2006
(86) PCT No.: PCT/AU06/01755

§ 371 Date: May 24, 2007

(30) Foreign Application Priority Data
Nov. 28, 2005 (AU) 2005906618

(51) Int. Cl. B01L 9/02; B32B 5/28

(52) U.S. Cl. 312/209; 442/226

(57) ABSTRACT

A seamless laboratory countertop (10) including an inner core (38) of relatively lightweight rigid material having top and bottom surfaces and at least one side surface extending between the top (42) and the bottom (44) surfaces. A reinforcement layer (40) of fiber-reinforced thermoset resin is secured to and covers the top and the bottom surfaces of the inner core (38), and a layer of thermoset resin is secured to and covers the side surface of the inner core. The thermoset resin on the side surface is the same as the thermoset resin of the reinforcement layer. The countertop also includes an outer layer (12) of non-reinforced thermoset resin secured to and covering the reinforcement layer over the top surface of the inner core to provide a smooth work surface.

### CLAIM OF PRIORITY

The present International Patent Application filed under the Patent Cooperation Treaty claims priority to Australian Patent Application No. 2005906618, filed on Nov. 28, 2005.

### TECHNICAL FIELD OF THE DISCLOSURE

The present disclosure relates to a panel having a chemical resistant work surface, and, more particularly, to a panel having a chemical resistant work surface that is suitable for use as a laboratory countertop. The present disclosure is also related to the manufacture, installation, and repair of such laboratory countertops.

### BACKGROUND OF THE DISCLOSURE

The present disclosure will be described with particular reference to a panel for use as a laboratory countertop. However, it should be noted that a panel according to the present disclosure might be used in other applications and no limitation is intended.

Laboratory countertops are a critical component of successful laboratory designs. Countertops experience most of the day-to-day use, and abuse, in the laboratory, and must be resistant to strong chemicals such as solvents, acids and corrosive compositions, and must also withstand severe physical conditions such as impacts and localized heating or freezing without breaking or cracking. In addition, the countertop must have a smooth, impermeable surface, which is easy to clean.

Laboratory countertops have been made of many different materials in an effort to meet these demanding performance requirements. Such materials have included, for example, natural stone, thermoplastics such as polypropylene, plastic laminates, solid phenolic resins, and epoxy resins. Typically, an epoxy resin countertop comprises a thick slab of cured epoxy resin containing a mineral filler. Fillers are used to counteract shrinkage of the resin during hardening and to reduce material costs. The slabs are cast in thicknesses of approximately 1 inch to 1½ inches, in lengths of up to 8 feet and in widths of up to 4 feet. Epoxy countertops of this general type have performed quite well under the demanding environmental conditions encountered in laboratories, and have been used extensively. Indeed, this type of countertop is used in most academic and industrial laboratory countertop installations. However, a drawback to this type of countertop is that it is quite heavy. A typical epoxy countertop slab may weigh 10 pounds or more per square foot. Thus, the material cost and shipping expense is significant and the heavy weight also makes handling and installation difficult and more costly.

Another drawback of epoxy countertops is that repairing a cast epoxy countertop is difficult, labor intensive and in some cases impractical if the countertop is scratched or cracked (e.g. by impact). Another drawback is that cast epoxy countertops have to be installed using specialized tools, such as diamond tipped saw blades and diamond tipped drill bits, using techniques not familiar to the typical builder. A further drawback is that sinks cannot be installed in cast epoxy countertops in a seamless manner.

What is still desired is a new and improved panel that can be used as a laboratory countertop and integrated parts, such as a sink and a splashguard. Preferably, the new and improved countertop will be made from relatively inexpensive materials yet will provide the appearance of being a solid, heavy slab without joints, and will be chemical resistant, temperature resistant, and impact resistant. In addition, it is preferred that the new and improved countertop will be lightweight, and thus easier to handle and cheaper to ship, and will also be relatively easy to install, clean, and repair.

### SUMMARY OF THE DISCLOSURE

The present disclosure provides a lightweight countertop that can receive a sink, a backsplash, and laboratory fixtures. The countertop includes an inner core of lightweight rigid material, a reinforcement layer of fiber-reinforced chemical and thermal-resistant thermoset resin over the inner core, and an outer layer of a non-reinforced chemical and thermal-resistant thermoset resin over the reinforcement layer. Both of the reinforcement layer and the outer layer are positioned on at least a top surface of the inner core to create a work surface of the countertop. The countertop also includes a reinforcement layer on a bottom surface of the inner core.

According to one aspect of the present disclosure, the inner core is between about 15 and 40 mm, the reinforcement layer is between about 2 and 6 mm, and the outer layer is between about 0.4 and 1.6 mm.

According to another aspect, the inner core is balsa wood, and the thermoset resin of the reinforcement layer and the outer layer is a vinyl ester resin.

According to a further aspect, the reinforcement of the reinforcement layer is glass fiber.

The present disclosure also provides a method for manufacturing the countertop described above. The method includes providing a two-part mold shaped and adapted to mold a panel suitable for use as a countertop. The two-part mold is first opened, and an inner face of a first part of the two-part mold is coated with a thermoset resin to form the outer layer of the countertop, and the resin is allowed to at least partially cure. Fibrous reinforcing material is then placed over the partially cured outer layer, and a first surface of the lightweight core is placed over the fibrous reinforcing material. Additional fibrous reinforcing material is placed over a second, opposite surface of the lightweight core. The method further includes closing the two-part mold, creating a vacuum in the closed mold, and injecting thermoset resin into the closed two-part mold such that the fibrous reinforcing material is infused with the injected thermoset resin to create a reinforcement layer, and adhered to the lightweight core and the outer surface. Side surfaces of the lightweight core are also coated with the injected thermoset resin to create an outer layer on the side surfaces, which may or may not be reinforced as desired. The layers are then allowed to cure before the mold is opened and the panel is removed.

The present disclosure, therefore, provides a new and improved countertop that can be made from relatively inexpensive materials yet provides the appearance of being a solid, heavy slab without joints, and is chemical, temperature, and impact resistant. In addition, the new and improved countertop is lightweight, and thus easier to handle and cheaper to ship, and is also relatively easy to install, clean, and repair. The new countertop can be installed using everyday wood working tools, such as saws and drills, using common building techniques. In addition, because the new countertops are lightweight, pieces of countertop can simply be glued together, or glued to the supporting frames and cabinets, using just the resin.

Additional aspects and advantages of the present disclosure will become readily apparent to those skilled in this art from the following detailed description, wherein only an exemplary embodiment of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF DRAWINGS

Reference is made to the attached drawings, wherein elements having the same reference character designations represent like elements throughout, and wherein:

FIG. 1 is a top and side perspective view of an exemplary embodiment of a laboratory countertop according to the present disclosure;

FIG. 2 is an enlarged sectional view of a portion of the laboratory countertop of FIG. 1;

FIG. 3 is a flow chart illustrating an exemplary embodiment of a method according to the present disclosure for manufacturing the laboratory countertop of FIG. 1;

FIG. 4 is an enlarged sectional view of a portion of the laboratory countertop of FIG. 1 during installation of the countertop, wherein an edge piece is shown being attached to a cut end of the countertop;

FIG. 5 is a perspective view showing an exemplary embodiment of a method for joining two lengths of the laboratory countertop of FIG. 1 during installation of the countertop; and

FIGS. 6a-6d are enlarged sectional views of a portion of the laboratory countertop of FIG. 1, wherein an exemplary embodiment of a method for repairing a work surface of the countertop is shown.

### DETAILED DESCRIPTION OF EXEMPLARY EMBODIMENTS

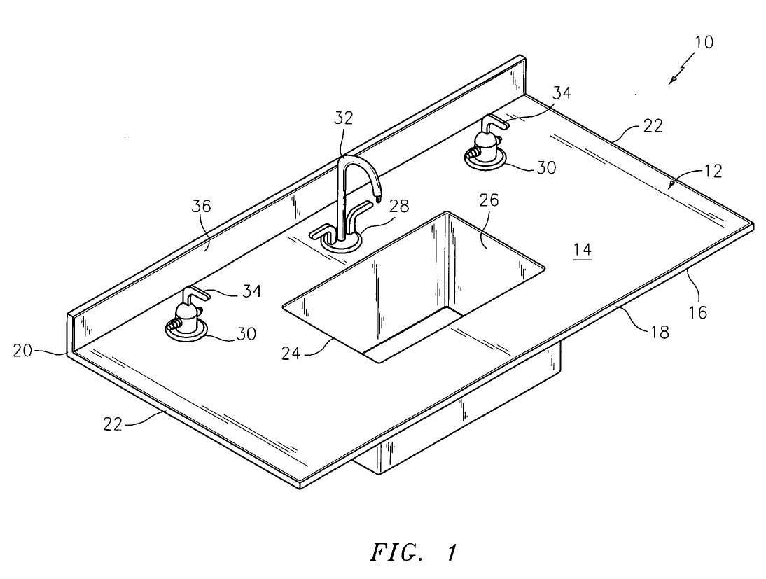

Referring first to FIG. 1, there is shown an exemplary embodiment of a seamless laboratory countertop 10 according to the present disclosure. As shown, the countertop 10 includes a smooth outer layer 12 covering a top work surface 14 of the countertop 10. The outer layer 12 is a non-porous, non-reinforced chemical and thermal-resistant thermoset resin. Although not viewable in FIG. 1, the countertop 10 also includes a bottom surface 16 that is not covered with the outer layer 12. Layers of non-reinforced thermoset resin cover side surfaces 18, 20, 22 of the countertop 10 to provide a finished appearance. The thermoset resin of the side surfaces 18, 20, 22 can be the same resin as used in the outer layer 12 covering the work surface 14.

In the exemplary embodiment shown in FIG. 1, the laboratory countertop 10 is rectangular (as viewed from above) and includes a front side surface 18, a rear side surface 20, and two end side surfaces 22. In addition, the laboratory countertop 10 includes a large opening 24 receiving a sink 26, three smaller openings 28, 30 receiving fixtures, including a water faucet 32 and two gas valves 34, and a backsplash 36 secured to the rear side surface 20 of the countertop 10. It should be understood however that the countertop 10 can be provided in many other different shapes, such as square, round, and oblong, and include different numbers of openings and attachments, as desired. The sink 26 and the backsplash 36 can be unitarily formed in a mold with the countertop 10 during manufacturing, or may be attached to the countertop 10 after the countertop has been molded. If not molded together, the sink 26 and backsplash 36 can be attached to the countertop 10 either at the factory or during installation in a laboratory. In all cases, however, the final assembled and installed countertop 10, sink 26, and backsplash 36 are provided as a seamless and unitary piece. By “seamless” it is meant that there are no lines, ridges, grooves, cracks, fissures, or wrinkles on the countertop itself, between the sink and the countertop, or between the backsplash and the countertop.

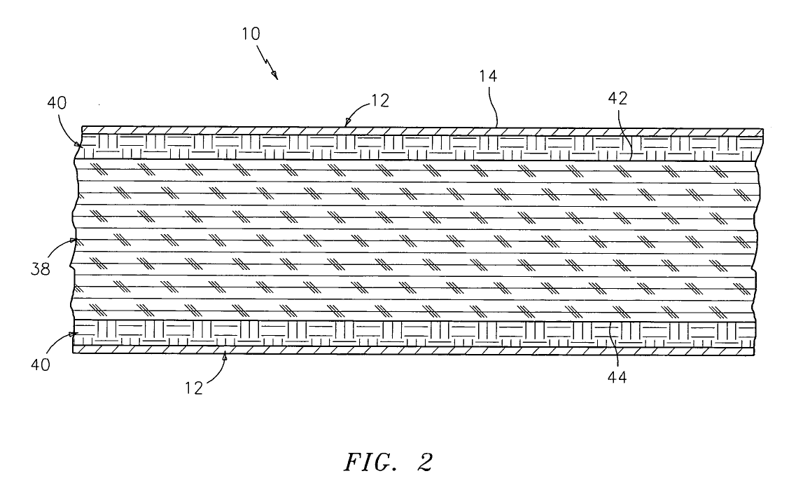

Referring to FIG. 2, the countertop 10 includes an inner core 38 of lightweight rigid material, and a reinforcement layer 40 of fiber-reinforced chemical and thermal-resistant thermoset resin over the inner core 38. The outer layer 12 of a non-reinforced chemical and thermal-resistant thermoset resin is positioned over the reinforcement layer 40.

Both of the reinforcement layer 40 and the outer layer 12 are positioned on at least a top surface 42 of the inner core 38 to create the work surface 14 of the countertop 10. The countertop 10 also includes a reinforcement layer 40 on a bottom surface 44 of the inner core 38. In the exemplary embodiment shown, the outer layer 12 is also provided on the reinforcement layer 40 on the bottom surface 44 of the inner core 38. Side surfaces of the inner core 38 are covered with non-reinforced thermoset resin to create the side surfaces 18, 20, 22 of the countertop 10 to provide a finished appearance. The side surfaces 18, 20, 22 of the countertop 10 are the same resin as used in the reinforcement layer 40. The side surfaces 18, 20, 22 may include the reinforcement layer 40.

According to one exemplary embodiment, the inner core 38 has a thickness of between about 15 and 40 mm, the reinforcement layer 40 has a thickness of between about 2 and 6 mm and preferably about 4 mm, and the outer layer 12 has a thickness of between about 0.4 and 1.6 mm, and preferably between about 0.5 and 0.7 mm.

The inner core 38 is made from a material that is lightweight. By “lightweight,” it is meant that the inner core 38 is lighter than an inner core 38 made exclusively from a thermoset resin. Suitable core materials include balsa wood, paulonia, and thermoplastic foam.

Suitable thermoset resins for the outer layer 12 include polyester, vinyl ester, vinyl ester-polyester blends, fluorinated vinyl ester, and epoxy vinyl ester. Bisphenol A based epoxy vinyl ester resins are preferred. Examples of currently commercially available resins of this type are Derakane® and Hetron® resins sold by Ashland Inc. of Covington, Ky. (www.ashland.com). Derakane® 411-350 and Hetrone 922 resins are preferred. A suitable vinyl ester gel coat is available from Huntsman Chemical (www.huntsman.com).

The outer layer 12 has a smooth finish and may be clear or may include a pigment or filler for color. The thermoset resin of the reinforcement layer 40 may be the same as the outer layer 12 or may be different, providing that the two resins are compatible in that they provide suitable adhesion to each other. For example, the resin of the reinforcement layer 40 may, for example, have a lesser degree of chemical resistance or have a rougher texture than the outer layer 12, since the reinforcement layer 40 is covered and protected by the outer layer 12. A less expensive resin may be used in the reinforcement layer 40.

The fibrous reinforcement of the reinforcement layer 40 can include any suitable material including glass, fabric, carbon, and polymeric fibrous material such as Kevlar®. Glass fibrous materials are particularly preferred. Suitable glass fiber includes surfacing veils, chopped strand, chopped strand matt, woven roving, biaxial mat, continuous strand and unidirectional mat.

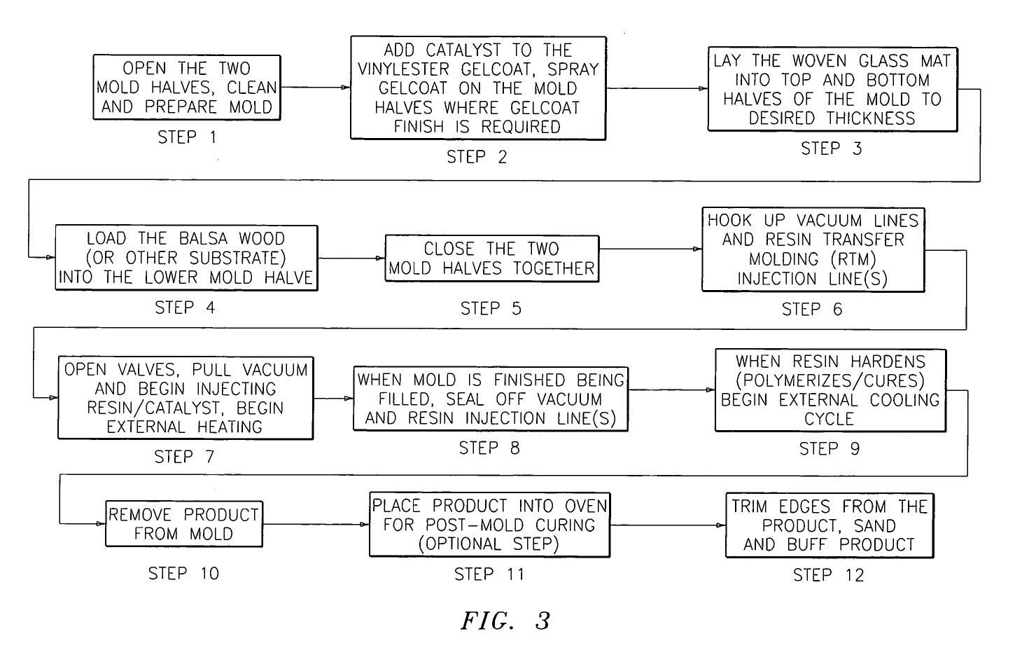

The present disclosure also provides a method for manufacturing the countertop 10 described above, using resin transfer molding (RTM). An exemplary embodiment of the method is illustrated by the flow chart in FIG. 3. The method includes providing a two-part mold shaped and adapted to mold a panel suitable for use as a countertop 10. The two-part mold is first opened, cleaned, and prepared (e.g., wax release agent applied), as shown in STEP 1.

As shown in STEP 2, thermoset resin (i.e., gelcoat) is prepared and sprayed onto an inner face of a first part of the two-part mold to form the top outer layer 12 (i.e., work surface 14) of the countertop 10, and the resin is allowed to at least partially cure. The time taken to cure will depend on a number of factors such as choice of promoter, initiator, temperature, and the like. The gelcoat may be suitably pigmented or contain carbon to provide color. If desired inner faces of both parts of the mold can be sprayed to form outer layers 12 above and below the countertop 10. According to one exemplary embodiment, the vinyl ester gelcoat is JB9577 gelcoat available from Huntsman Chemical, and is sprayed to a thickness of 0.8 mm.

Fibrous reinforcing material is then placed over the inner faces of both parts of the mold to form the reinforcement layers 40, as shown in STEP 3. A first of the reinforcement layers 40 will be positioned between the top surface 42 of the inner core 38 and the outer surface formed on the first part of the mold (i.e., the top work surface 14), and a second of the reinforcement layers 40 will be positioned on the bottom surface 44 of the inner core 38. The reinforcement layers 40 may extend onto the side surfaces. According to one exemplary embodiment, the reinforcement layers 40 comprise a composite layer of fiberglass resin in the amount of 700 grams/square meter. The composite layer includes a layer of reinforcing glass by an infiltration layer of random glass veil.

Then, as shown in STEPS 4 and 5, the inner core 38 is positioned in the mold between the fibrous reinforcing materials of the reinforcement layers 40, and the two-part mold is closed. The surfaces of the inner core 38 can be coated with a resin compatible with the resin of the reinforcement layer 40 and allowed to harden but not cure prior to placing the core in the mold. The resin is soaked into the surface of the inner core 38 before curing.

Referring to STEPS 6 through 8, the method further includes creating a vacuum in the closed mold, injecting thermoset resin into the closed two-part mold, and providing external heating to the mold. The fibrous reinforcing material is infused with the injected thermoset resin to create the reinforcement layers 40, and the injected thermoset resin also adheres to the lightweight core 38 and the outer layer 12. Side surfaces of the lightweight core 38 are also coated with the injected thermoset resin to create a non-reinforced outer layer on the side surfaces 18, 20, 22 of the countertop 10. Alternatively, the reinforcement layers 40 may extend over the side surfaces of the lightweight core 38 to create a reinforced outer layer on the side surfaces 18, 20, 22 of the countertop 10. According to one exemplary embodiment, the infused epoxy vinyl ester resin comprises Hetron 922 from Ashland Chemicals and, once cured, the reinforcement layers 40 each have a thickness of about 4 mm.

The layers are then allowed to cure. In one exemplary embodiment, the molds are designed so that heat can be supplied to the surrounding mold parts via circulating heating fluid or electrical heating blankets to assist the resin to cure in a more thorough manner. The external heating results in additional cross-linking of the thermoset polymer to provide improvements to properties such as chemical resistance. After curing, an external cooling cycle is carried out for a set period, and then the mold is opened and the panel is removed, as shown in STEPS 9 and 10. Edges are then trimmed from the panel, and the outer layer 12 of the panel is sanded and buffed to provide smooth finished surfaces. The molded and finished panel can then be shipped to a laboratory or other facility and assembled into a finished countertop 10.

Referring back to FIG. 1 it should be noted that the sink 26 and the backsplash 36 can be unitarily formed with the countertop 10 during the molding process so as to be seamlessly joined. Alternatively, the sink 26 and the backsplash 36 can be attached to the countertop 10 during the installation process, after the countertop 10 has been molded as a separate piece. The assembled countertop 10, sink 26, and backsplash 36 can then be made to appear to be seamlessly joined by the application of resin to the joints and sanding of the cured resin to provide a smooth finished surface.

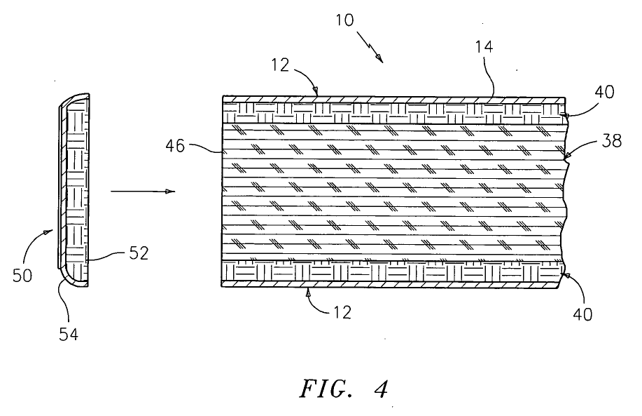

During installation of the countertop 10 the molded panels can be cut (using a circular saw for example) to fit. As shown in FIG. 4, a sidepiece 50 can be adhered to the cut end 46 of the panels 10 using vinyl ester resin. Then vinyl ester resin can be applied to the joints between the cut end 46 and the sidepiece 50, allowed to cure, and sanded to provide a seamless finish. The sidepiece 50 itself may be cut from the end of a discarded piece of panel during installation of the countertop 10, or can be manufactured separately and sold with the panels. In the exemplary embodiment shown in FIG. 4, the sidepiece 50 includes a reinforcement layer 52 as well as a finished outer layer 54. Alternatively, the sidepiece 50 can include just an outer layer 54.

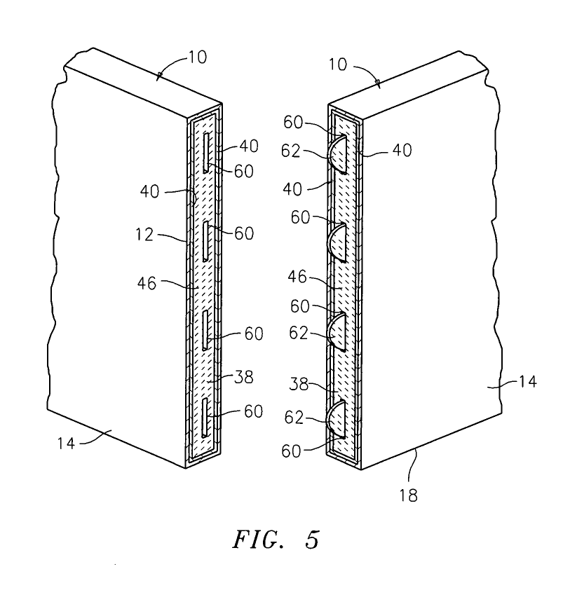

Separate molded panels can be joined end to end to form a longer countertop 10, and the joints between the panels can also be made to appear to be seamless. FIG. 5 illustrates an exemplary embodiment of a method for connecting cut ends 46 of two molded panels in order to form a longer countertop 10. As shown, the ends 46 are biscuit joined so that the adjoining work surface 14s form a smooth continuous surface. The biscuit joining includes cutting aligned notches 60 in the ends 46 of the panels, filling the notches with resin, inserting biscuits 62 into the notches of one of the panels (as shown in FIG. 5), and bringing the ends together so that the biscuits 62 are also inserted in the notches 60 of the other panel. Resin is then applied to the joint between the panels, allowed to cure, and sanded so that the joint appears seamless.

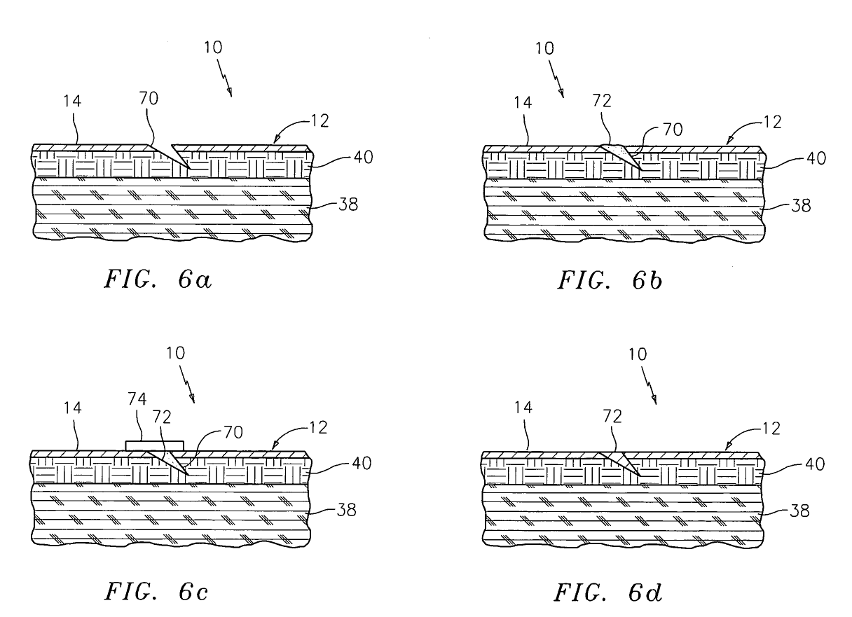

FIGS. 6a-6d show a method for repairing a damaged work surface 14 of a countertop 10 constructed in accordance with the present disclosure. In the exemplary embodiment shown, the damage is a gash 70 that extends through the outer layer 12 and into the reinforcement layer 40, as shown in FIG. 6a. The repair includes cleaning and sanding the gash 70, and then filling the gash with resin 72, as shown in FIG. 6b. The resin is then allowed to cure. While the resin 72 is curing the resin can be covered with a flat non-stick protective piece of material 74, as shown in FIG. 6c, in order to form a flat and even surface between the resin and the work surface 14. Once cured the resin 72 is uncovered, and sanded to provide a seamless repair, as shown in FIG. 6d.

The present disclosure, therefore, provides a new and improved countertop that is made from relatively inexpensive materials yet provides the appearance of being a solid, heavy slab without joints. The countertop is chemical, temperature, and impact resistant, and the countertop is lightweight. Being lightweight, the countertop is easier to handle and cheaper to ship and install. The countertop is also relatively easy to install, clean, and repair.

It should be understood that the exemplary embodiments described in this specification have been presented by way of illustration rather than limitation, and various modifications, combinations and substitutions may be effected by those skilled in the art without departure either in spirit or scope from this disclosure in its broader aspects.

1. A seamless laboratory countertop comprising:
an inner core of relatively lightweight rigid material having top and bottom surfaces and at least one side surface extending between the top and the bottom surfaces;
a reinforcement layer of fiber-reinforced thermoset resin secured to and covering the top and the bottom surfaces of the inner core;
a layer of thermoset resin secured to and covering the side surface of the inner core, wherein the thermoset resin on the side surface is the same as the thermoset resin of the reinforcement layer; and
an outer layer of non-reinforced thermoset resin secured to and covering the reinforcement layer over the top surface of the inner core.

2. A seamless laboratory countertop according to claim 1, wherein the outer layer comprises a non-porous, non-reinforced chemical and thermal-resistant thermoset resin.

3. A seamless laboratory countertop according to claim 1, wherein the outer layer is secured to and covers the reinforcement layer over the bottom surface of the inner core.

4. A seamless laboratory countertop according to claim 1, wherein the countertop includes a large opening adapted to receive a sink and at least one smaller opening adapted to receive a fixture.

5. A seamless laboratory countertop according to claim 1, further comprising a sink and a backsplash seamlessly secured to the countertop.

6. A seamless laboratory countertop according to claim 1, wherein the inner core has a thickness of between about 15 and 40 mm.

7. A seamless laboratory countertop according to claim 1, wherein the reinforcement layer has a thickness of between about 2 and 6 mm.

8. A seamless laboratory countertop according to claim 1, wherein the reinforcement layer has a thickness of about 4 mm.

9. A seamless laboratory countertop according to claim 1, wherein the outer layer has a thickness of between about 0.4 and 1.6 mm.

10. A seamless laboratory countertop according to claim 1, wherein the outer layer has a thickness of between about 0.5 and 0.7 mm.

11. A seamless laboratory countertop according to claim 1, wherein the inner core is made from one of balsa wood, paulonia, and thermoplastic foam.

12. A seamless laboratory countertop according to claim 1, wherein the thermoset resin of the outer layer comprises one of polyester, vinyl ester, vinyl ester-polyester blends, fluorinated vinyl ester, and epoxy vinyl ester.

13. A seamless laboratory countertop according to claim 1, wherein the thermoset resin of the outer layer comprises Bisphenol A based epoxy vinyl ester resin.

14. A seamless laboratory countertop according to claim 13, wherein the thermoset resin of the outer layer includes a pigment or filler for color.

15. A seamless laboratory countertop according to claim 1, wherein the thermoset resin of the outer layer is the same as the thermoset resin of the reinforcement layer.

16. A seamless laboratory countertop according to claim 1, wherein fibrous reinforcement of the reinforcement layer comprises one of glass, fabric, carbon, and polymeric fibrous material.

17. A seamless laboratory countertop according to claim 1, wherein fibrous reinforcement of the reinforcement layer is glass and comprises one of surfacing veils, chopped strand, chopped strand matt, woven roving, biaxial mat, continuous strand and unidirectional mat.

18. A seamless laboratory countertop according to claim 1, wherein fibrous reinforcement of the reinforcement layer comprises a composite layer of reinforcing glass and an infiltration layer of random glass veil.

19. A seamless laboratory countertop according to claim 1, wherein fibrous reinforcement of the reinforcement layer comprises fiberglass resin in the amount of about 700 grams/square meter.

20. A seamless laboratory countertop according to claim 1, wherein the countertop comprises two panels joined end to end at a joint secured with biscuits, and wherein the joint is covered with cured and sanded resin to provide a seamless appearance.

21. A seamless laboratory countertop according to claim 1, wherein the layer of thermoset resin secured to and covering the side surface of the inner core includes fibrous reinforcement.
